(19) United States
(12) Patent Application Publication
(10) Pub. No.: US 2009/0014132 A1
(43) Pub. Date: Jan. 15, 2009

(54) Window covering switchable to manual operation and electrical operation and a clutch thereof

(76) Inventor: Li-Ming Cheng, Kaohsiung City (TW)

Correspondence Address: Frenkel & Associates, P.C., Suite 330, 3975 University Drive, Fairfax, VA, 22030, US

(21) Appl. No.: 11/825,967

(22) Filed: Jul. 10, 2007

(51) Int. Cl. E06B 9/322; E06B 9/32

(52) U.S. Cl. 160/168.1 P

(57) ABSTRACT

A window covering switchable to manual operation and electrical operation includes at least an upper elongated member, a lower elongated member, a shade lift cord assembly, an electric transmission assembly, a clutch and an automatic retraction means. The electric transmission assembly is coupled with the clutch through an axle of a gear box to drive a driving gear thereon to rotate. The driving gear is engaged with a driven gear pivotally coupled with the automatic retraction means to form a synchronous transmission thereby to control retraction and extension of the electric window covering. When electric power is not available manual operation may be switched through the clutch to extend or retract the window covering.

### FIELD OF THE INVENTION

The present invention relates to a window covering switchable to manual operation and electrical operation and particularly to a window covering that has a shade assembly driven manually and electrically through a clutch.

### BACKGROUND OF THE INVENTION

There are many types of window coverings available on the market, such as blinds, pleated shade, roman shade and the like. They mainly are installed on windows or doors in houses to block sunshine and provide decorative function. While consumer's requirements may be different, safety always is an important issue. Taking this issue into account, an electrically driven window covering usually is adopted to control rising up or lowering down of the window covering. However, the electric window covering still has problems when in use, notably:

1. When the conventional electric window covering is in a no power condition the motor and gear box are not functioning, lowering down or rising up the window covering by hands is difficult.

2. When the conventional electric window covering is in a no power condition to lower down or roll up the window covering at a desired elevation and anchored there is more difficult. As a result the practicality of the window covering suffers.

### SUMMARY OF THE INVENTION

The primary object of the present invention is to provide a window covering that can be switched to manual operation and electrical operation to improve the shortcomings of the conventional electric window covering that cannot be rolled up or lowered at a desired elevation manually when electric power is not available. The invention includes an electric transmission assembly which has a control module at an upper side containing a battery. By depressing a pushbutton a driving gear in a clutch is lowered to engage with a driven gear to perform transmission synchronously to control rising up and extension of the window covering electrically. When electric power is not available the battery can be removed to move the driving gear higher to disengage with the driven gear, and the window covering can be extended or rolled up by switching to a manual operation.

Another object of the invention is to provide a clutch for electric window coverings to improve the problem of the conventional electric window covering that cannot be rolled up or extended the window covering at a desired elevation manually when the electric power is not available. The electric transmission assembly includes a gear box which has an axle connecting to the clutch. By depressing the pushbutton the driving gear in the clutch is lowered to engage with the driven gear to do transmission synchronously to control rising up and extension of the window covering electrically. When the pushbutton is released the driving gear is moved higher to disengage with the driven gear, and the window covering can be extended or rolled up by switching to the manual operation.

To achieve the foregoing objects the window covering switchable to manual operation and electrical operation of the invention includes at least an upper elongated member, a lower elongated member, a shade lift cord assembly, an electric transmission assembly, a clutch and an automatic retraction means. The electric transmission assembly, clutch and automatic retraction means are located in the upper elongated member. The electric transmission assembly can be coupled with the clutch through an axle of a gear box. Through a driving gear pivotally coupled on the clutch, a driven gear can be engaged to provide synchronous transmission.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is an exploded view of an upper elongated member of the invention.

FIG. 3 is an exploded view of a control module of the invention.

FIG. 4 is a fragmentary perspective view of the invention.

FIG. 5 is an exploded view of a clutch of the invention.

FIG. 6 is a schematic view of the invention showing a pushbutton of the battery is depressed to activate the clutch.

FIG. 7 is a schematic view of the invention showing a driving gear and a driven gear are engaged to perform transmission.

FIG. 8 is a schematic view of the invention without containing the battery and the pushbutton not being depressed.

FIG. 9 is an exploded view of a second embodiment of the clutch of the invention.

FIG. 10 is a schematic view according to FIG. 9 showing the pushbutton of the battery is depressed to activate the clutch.

FIG. 11 is a schematic view according to FIG. 9 without containing the battery and the pushbutton not being depressed.

FIG. 12 is a schematic view of a third embodiment of the clutch of the invention.

FIG. 13 is a schematic view according to FIG. 12 without containing the battery and a pusher.

FIG. 14 is a schematic view of a fourth embodiment of the clutch of the invention.

### DETAILED DESCRIPTION OF THE PREFERRED EMBODIMENTS

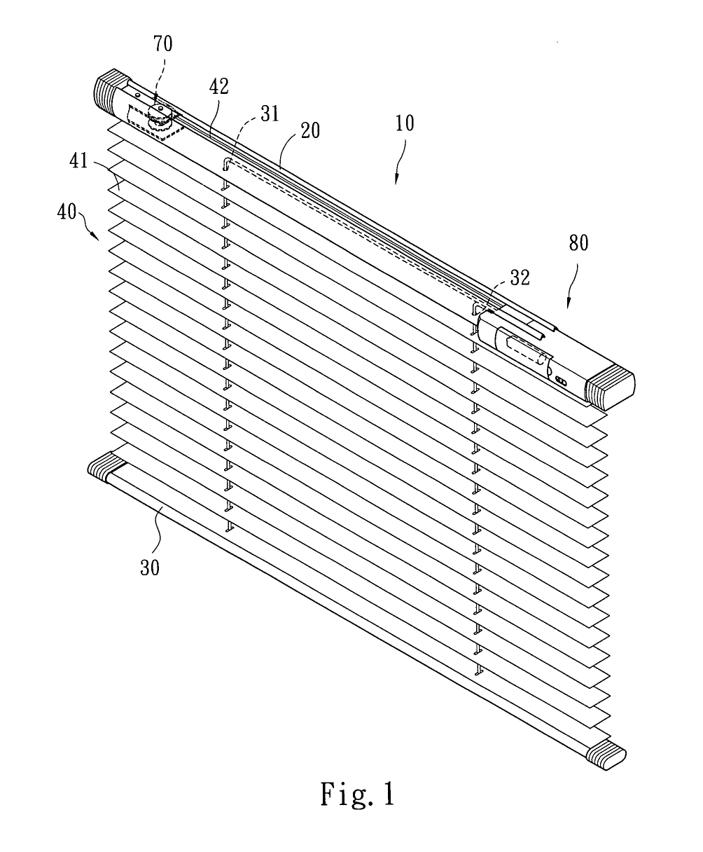

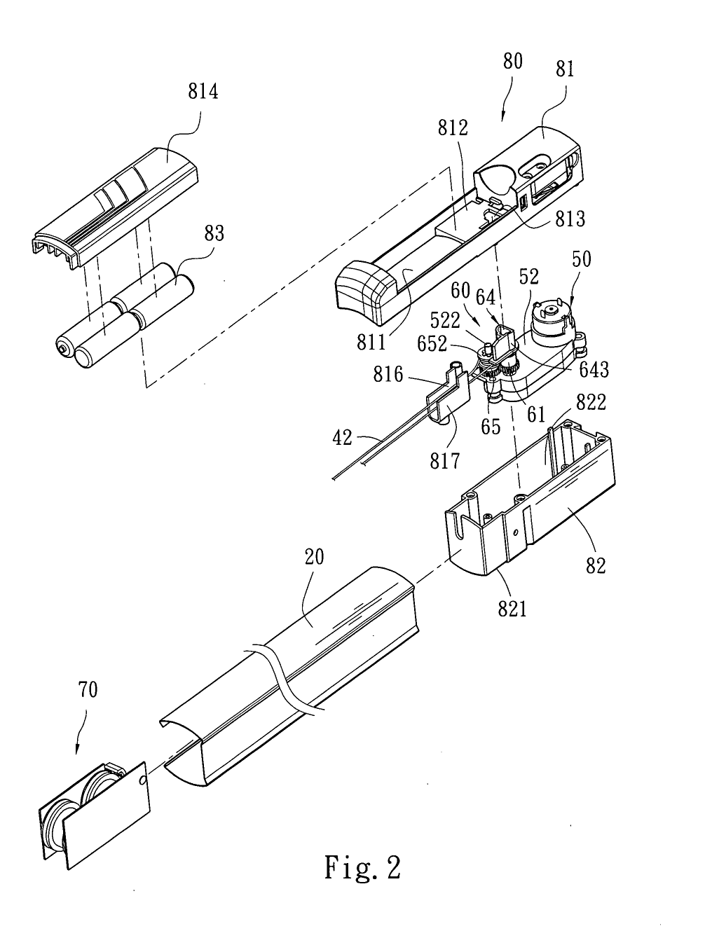

Please refer to FIGS. 1 and 2, the electric window covering 10 of the invention includes an upper elongated member 20 which holds an automatic retraction means 70 at one side. The automatic retraction means 70 is coupled with a clutch 60 and an electric transmission assembly 50. Thus the automatic retraction means 70 and the clutch 60 are engaged to form a synchronous transmission. As a result, the electric window covering 10 originally driven electrically can be switched to manual operation through the clutch 60 to roll up and extend the window covering 10. In an embodiment shown in the drawings the electric window covering 10 mainly includes the upper elongated member 20, a lower elongated member 30, a shade lift cord assembly 40, the electric transmission assembly 50, the clutch 60 and the automatic retraction means 70.

The upper elongated member 20 is a hollow and elongate rail with two ends having respectively an opening 31 and 32 formed thereon.

The lower elongated member 30 is another elongate rail spaced from the upper elongated member 20 at a lower side.

The shade lift assembly 40 is located between the upper elongated member 20 and the lower elongated member 30, and includes mainly shade 41 and a lift cord assembly 42. The shade 41 may be shade of a Venetian blind or a pleated shade. The shade 41 shown in the embodiment of the drawings are shade of a Venetian blind. They are linked to the upper elongated member 20 and the lower elongated member 30. The lift cord assembly 42 has one end fastened to the automatic retraction means 70 at one side of the upper elongated member 20 and other end threaded through the openings 31 and 32 and the shades 41 to be fastened to the lower elongated member 30.

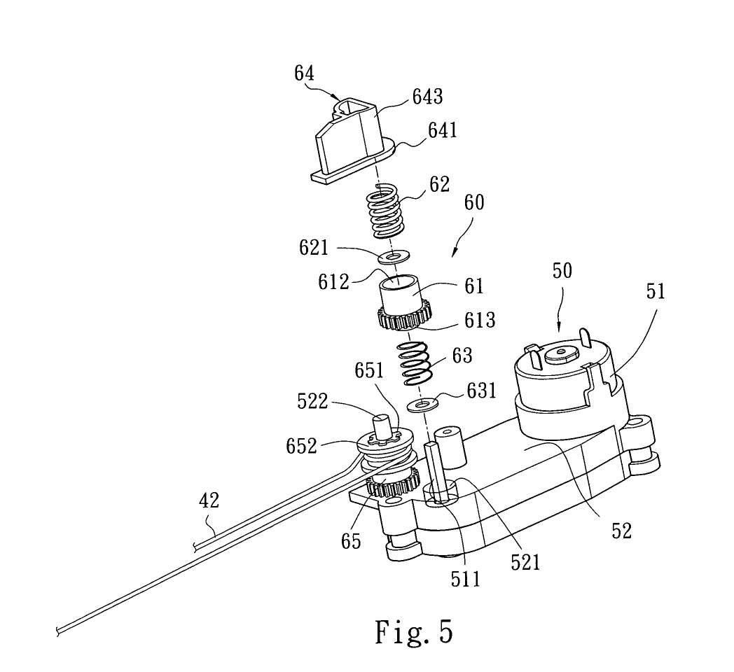

Also referring to FIGS. 2, 3 and 5, the electric transmission assembly 50 is located in a control module 80 at another side of the upper elongated member 20. It mainly includes a motor 51 and a gear box 52 coupled with a motor 51. The motor 51 is located at one end of the gear box 52. The gear box 52 has an axle 511 running through a recess 521 formed at another end of the gear box 52. The gear box 52 has an anchor shaft 522 at another end to be wound by the lift cord assembly 42.

Also referring to FIGS. 1, 2 and 3, the control module 80 includes at least a battery box 81 and a base 82. The battery box 81 has a housing trough 812 and a lid 814 that form a housing space there between to hold at least one battery 83. The housing trough 812 also has a button hole 813 to be run through by a pushbutton 64. The base 82 has a side wedge end 821 to couple with another side of the upper elongated member 20. The base 82 has a holding compartment 822 to hold the motor 51 and the gear box 52 of the electric transmission assembly 50. The base 82 is fastened to the bottom end of the battery box 81.

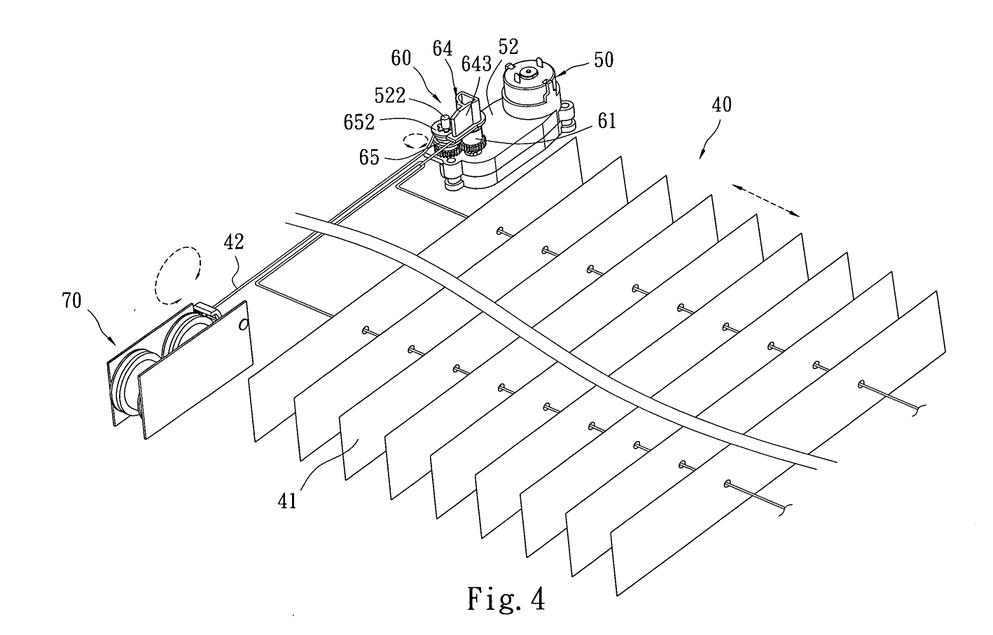

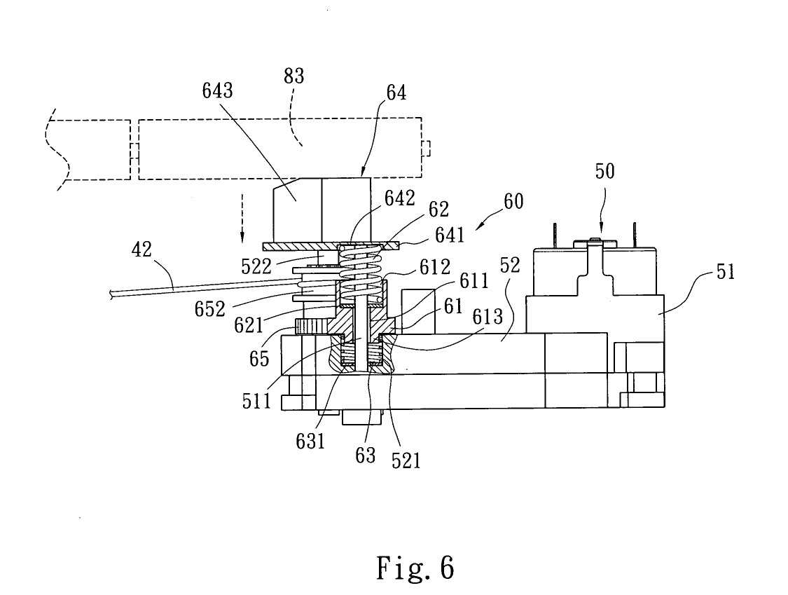

Referring to FIGS. 4, 5 and 6, the clutch 60 is coupled with the axle 511 of the gear box 52 of the electric transmission assembly 50. It includes at least a driving gear 61, an elastic element, the pushbutton 64 and a driven gear 65. In this embodiment the elastic element is a spring 63. The driving gear 61 has a top portion 612 and a bottom portion 613, and an aperture 611 in the center to be run through by the axle 511. The spring 63 has one end pressing the bottom portion 613 of the driving gear 61. The pushbutton 64 has a boss 643 and a bottom 641. The bottom 641 presses the top portion 612 of the driving gear 61. The driven gear 65 is held on the anchor shaft 522 of the gear box 52 and can be engaged with the driving gear 61 to form synchronous transmission. The driven gear 65 has a pulley 652 to be wound by the lift cord assembly 42 so that the pulley 652 can rotate synchronously with the driven gear 65.

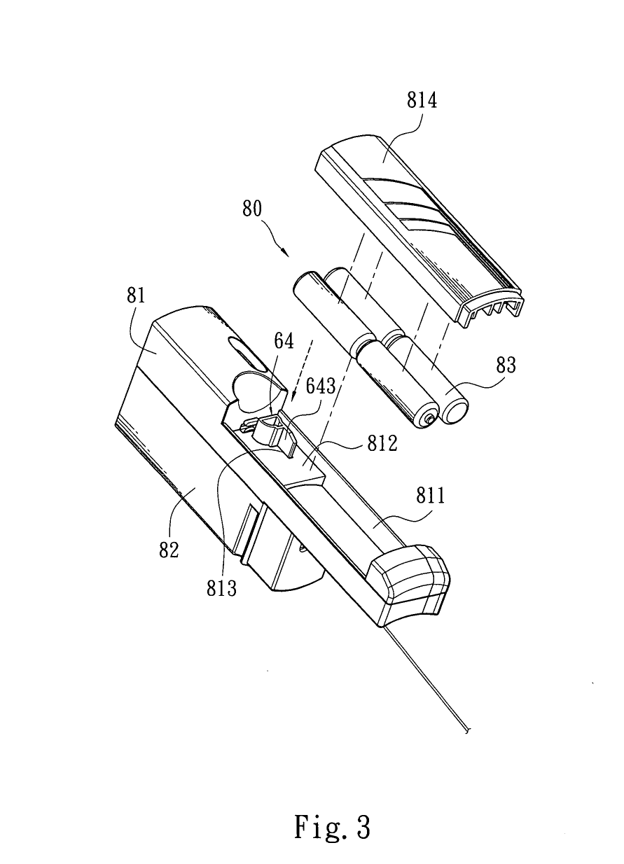

Referring to FIG. 3, the boss 643 at the upper end of the pushbutton 64 is formed with a cross section mating the button hole 813 of the housing trough 812 in any geometric shape desired. In FIGS. 2 and 3, the cross section of the boss 643 is substantially formed in a 7-shape with a hollow upper portion.

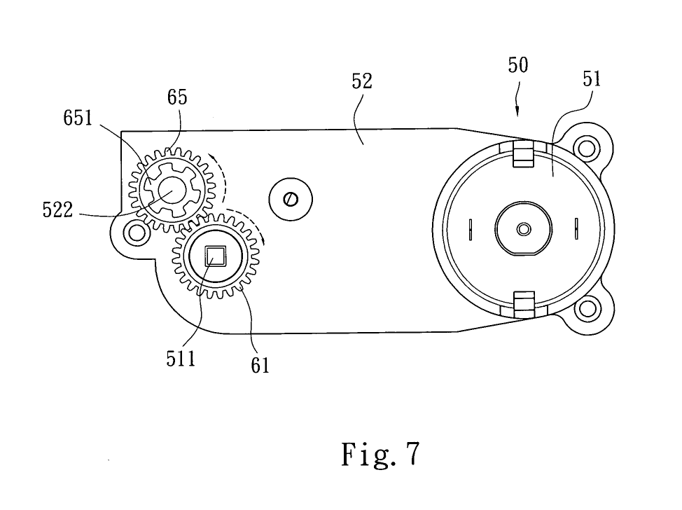

Referring to FIGS. 1, 4, 6 and 7, the automatic retraction means 70 is located in the upper elongated member 20 at one side. One end of the lift cord assembly 42 is fastened to one side of the automatic retraction means 70. The lift cord assembly 42 has other end winding on the pulley 652, then threading through the upper elongated member 20 to link the shades 41 and fasten to the lower elongated member 30. Thereby the automatic retraction means 70 is coupled with the driven gear 65 hinged on the anchor shaft 522 through the lift cord assembly 42, and the shade lift cord assembly 40 with the shade 41 threaded thereon can be extended or retracted by means of an elastic element (not shown in the drawings) of the automatic retraction means 70. As a result, the shade 41 can be extended or retracted manually.

Referring to FIGS. 1, 2 3 and 5, when the electric window covering 10 is in use to retract and extend the shade 41, the automatic retraction means 70 is coupled with the axle 511 of the gear box 52 of the electric transmission assembly 50 and the clutch 60. When the battery box 81 has the battery 83 held inside, by depressing the pushbutton 64 the driving gear 61 is pushed downwards and the driving gear 61 is moved downwards to engage with the driven gear 65. Thus rotation of the axle 511 also drives the driving gear 61 which in turn drives the driven gear 65 to rotate synchronously. And the shade lift cord assembly 40 threading the shades 41 is driven by the electric transmission assembly 50 and the clutch 60, and the electric window covering 10 can be retracted and extended electrically.

Referring to FIGS. 1, 3 and 8, when the battery 83 in the battery box 81 is removed, the electric window covering 10 loses electric power. The spring 63 of the clutch 60 pushes the driving gear 61 upwards to disengage with the driven gear 65. Then the electric window covering 10 that originally was driven electrically can be operated manually to cause the shade 41 to be retracted upwards or extended downwards. Thus through the clutch 60 the electric window covering 10 can be operated for retraction and extension as desired, either manually and electrically. Operation is more versatile and convenient.

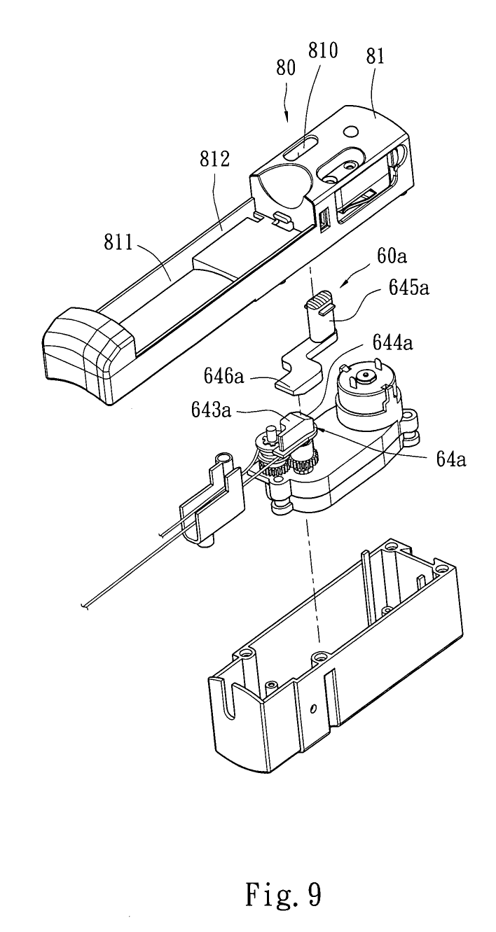

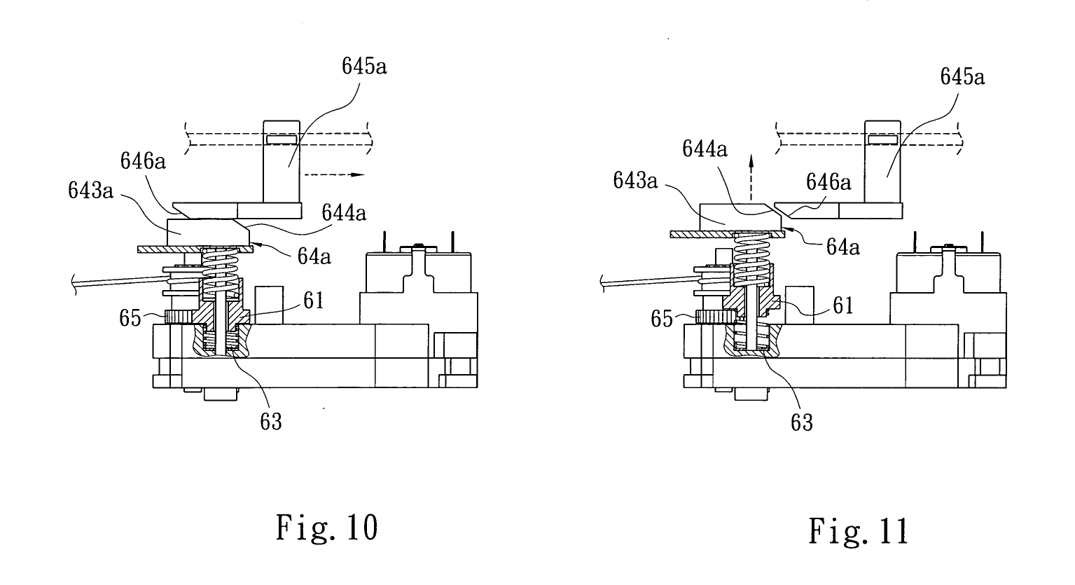

Refer to FIG. 9 for a second embodiment of the invention. The clutch 60a has a pusher 645a which has a slanted surface 646a at one end. The pushbutton 64a has a boss 643a at an upper end thereof that has a slope 644a at one end opposing the slanted surface 646a such that the slanted surface 646a is in contact with the slope 644a to press and release the pushbutton 64a. The electric window covering 10 has a battery box 81 which has a slot 810 to allow another end of the pusher 645a to extend outside the surface of the battery box 81. When the pusher 645a is moved on surface of the battery box 81 towards one end, the slanted surface 646a presses the pushbutton 64a, and the bottom of the pushbutton 64a compresses the driving gear 61 to engage with the driven gear 65. Therefore the window covering 10 can be operated electrically. When the pusher 645a is moved towards another end the pushbutton 64a is released, and the spring 63 pushes the driving gear 61 to escape the driven gear 65 (referring to FIGS. 10 and 11). Then the window covering 10 originally driven electrically can be switched to manual operation.

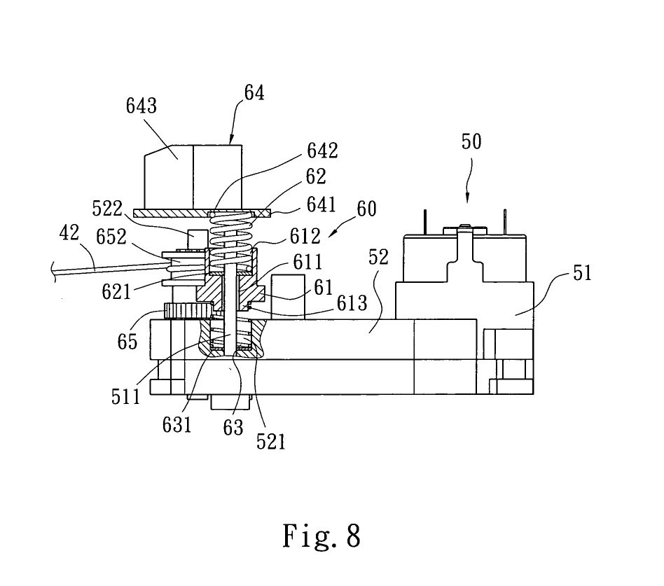

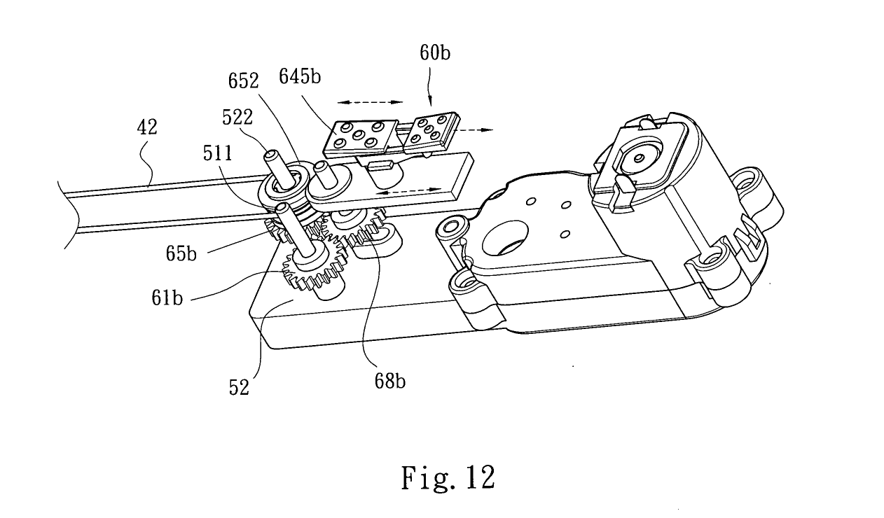

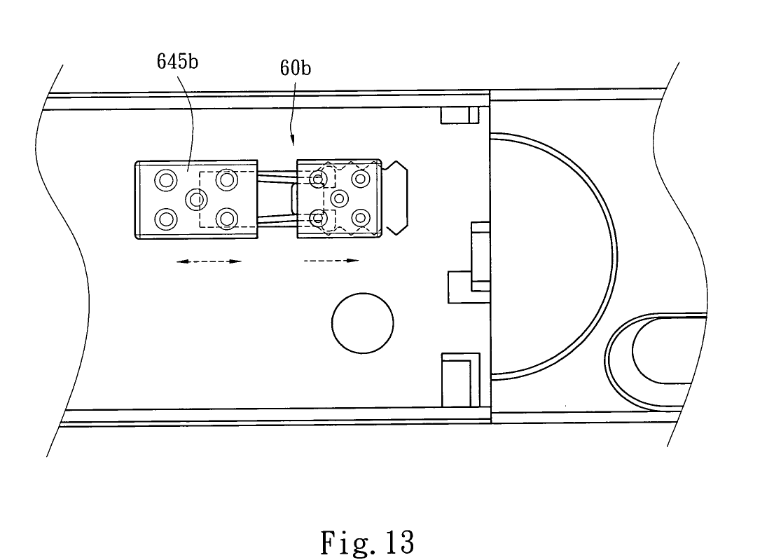

Refer to FIGS. 12 and 13 for a third embodiment of the invention. The clutch 60b includes at least a driving gear 61b, a driven gear 65b and a pusher 645b. The driving gear 61b is mounted onto the axle 511. The driven gear 65b is located on the anchor shaft 522 of the gear box 52. The driven gear 65b has a pulley 652 wound by the lift cord assembly 42 so that the pulley 652 can be rotated with the driven gear 65b synchronously. The pusher 645b has one end pivotally coupled with a middle gear 68b. The electric window covering 10 has a battery box (not shown in the drawings) same as the battery box 81 shown in the embodiment depicted in FIGS. 3 and 8. The battery box has a slot (not shown in the drawings) to allow another end of the pusher 645b to extend outside the surface of the battery box. The pusher 645b can be moved towards one end, and the middle gear 68b is engaged with the driving gear 61b and the driven gear 65b at the same time to allow the electric window covering 10 to be operated electrically. When the pusher 645b is moved towards another end the middle gear 68b is disengaged with the driving gear 61b and the driven gear 65b. Then the window covering 10 originally driven electrically can be switched to manual operation.

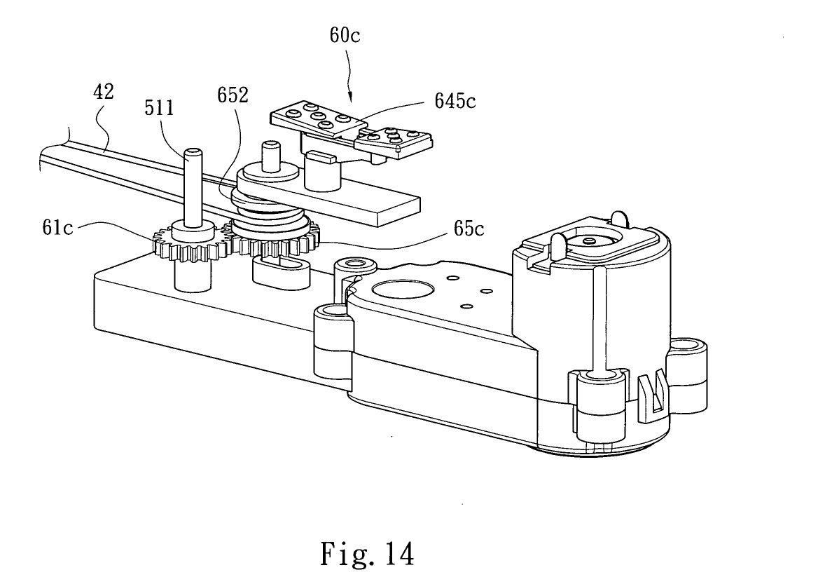

Refer to FIG. 14 for a fourth embodiment in which the clutch 60c includes at least a driving gear 61c, a driven gear 65c and a pusher 645c. The driving gear 61c is mounted onto the axle 511. The pusher 645c has one end pivotally coupled with the driven gear 65c which has a pulley 652 for winding the lift cord assembly 42 such that the pulley 652 can rotate with the driven gear 65c synchronously. The electric window covering 10 has a battery box (not shown in the drawings) same as the battery box 81 shown in the embodiment depicted in FIGS. 3 and 8. The battery box has a slot to allow another end of the pusher 645c to extend outside the surface of the battery box. The pusher 645c can be moved towards one end to allow the driving gear 61c to be engaged with the driven gear 65c so that the electric window covering 10 can be operated electrically. When the pusher 645c is moved towards another end the driving gear 61c and the driven gear 65c are disengaged. Then the window covering 10 originally driven electrically can be switched to manual operation.

What is claimed is:

1. A window covering switchable to manual operation and electrical operation, comprising:
an upper elongated member which is an elongate hollow rail and has an automatic retraction means and a control module;
a lower elongated member which is an elongate rail spaced from the upper elongated member at a lower side;
a shade lift cord assembly which is located between the upper elongated member and the lower elongated member and includes shade linking to the upper elongated member and the lower elongated member, and a lift cord assembly which has one end fastened to the automatic retraction means and other end linked to the shade and the lower elongated member;
an electric transmission assembly located in the control module; and
a clutch coupled with the electric transmission assembly to form connection between the automatic retraction means and the clutch through the lift cord assembly so that a synchronous transmission is formed among them, the electric window covering being switchable to electrical operation and manual operation through the clutch to be retracted and extended.

2. The window covering of claim 1, wherein the electric transmission assembly includes a gear box, the gear box having an axle.

3. The window covering of claim 2, wherein the gear box has an anchor shaft to be wound by the lift cord assembly.

4. The window covering of claim 1, wherein the control module includes at least a housing trough to hold a battery, the housing trough also having a button hole.

5. The window covering of claim 1, wherein the clutch includes at least:
a driving gear mounted on an axle; and
a driven gear which has a pulley to be wound by the lift cord assembly and is hinged on an anchor shaft;
wherein the driving gear is engaged with the driven gear to allow the window covering to be retracted and extended electrically; and the driving gear also is disengaged with the driven gear to allow the window covering to be retracted and extended manually.

6. The window covering of claim 5, wherein the clutch further includes an elastic element and a pushbutton, the driving gear having a top portion and a bottom portion, the driven gear being hinged on the anchor shaft of the gear box, the elastic element pressing the bottom portion of the driving gear, the pushbutton having a bottom pressing the top portion of the driving gear; the pushbutton being depressible to allow the bottom thereof to press the driving gear to engage with the driven gear; releasing the pushbutton causing the elastic element to press the driving gear to be disengaged with the driven gear.

7. The window covering of claim 6, wherein the pushbutton has a boss formed at an upper end thereof that has a slope at one end to form a pushing relationship with a slanted surface at one end of a pusher.

8. A clutch for an electric window covering which has a lift cord assembly to retract and extend shade, comprising:
a driving gear coupled on an axle; and
a driven gear which is hinged on an anchor shaft and has a pulley to be wound by the lift cord assembly;
wherein the driving gear is engaged with the driven gear to allow the electric window covering to be retracted and extended electrically; and the driving gear is also disengaged with the driven gear to allow the electric window covering to be retracted and extended manually.

9. The clutch for the electric window covering of claim 8 further including:
an elastic element pressing the bottom of the driving gear; and
a pushbutton which has a boss and a bottom pressing the driving gear; the pushbutton being depressible to allow the bottom thereof to press the driving gear to engage with the driven gear; releasing the pushbutton causing the elastic element to press the driving gear to be disengaged with the driven gear.

10. The clutch for the electric window covering of claim 9 further having a battery pressing the pushbutton to allow the driving gear to be engaged with the driven gear; the battery being removable to release the pushbutton to allow the elastic element to press the driving gear to be disengaged with the driven gear.

11. The clutch for the electric window covering of claim 10, wherein the electric window covering has a housing trough to hold the battery and a button hole to be run through by the pushbutton.

12. The clutch for the electric window covering of claim 9 further having a pusher pressing the pushbutton to allow the driving gear to be engaged with the driven gear; the pusher being movable to release of the pushbutton to allow the elastic element to press the driving gear to be disengaged with the driven gear.

13. The clutch for the electric window covering of claim 12, wherein the pusher has a slanted surface at one end, the boss of the pushbutton having a slope at one end opposing and in contact with the slanted surface to press and release the pushbutton.

14. The clutch for the electric window covering of claim 13, wherein the electric window covering has a battery box which has a slot to allow another end of the pusher to be extended outside the surface of the battery box.

15. The clutch for the electric window covering of claim 8 further including:
a pusher which has an anchor shaft at one end to be pivotally coupled with the driven gear;
wherein the pusher is movable towards one end to allow the driving gear to be engaged with the driven gear; the pusher being movable towards another end to allow the driving gear to be disengaged with the driven gear.

16. The clutch for the electric window covering of claim 15, wherein the electric window covering has a battery box which has a slot to allow another end of the pusher to be extended outside the surface of the battery box.

17. A clutch for an electric window covering which has a lift cord assembly to retract and extend shades, comprising:
a driving gear coupled on an axle;
a driven gear which is hinged on an anchor shaft and has a pulley to be wound by the lift cord assembly; and
at least one middle gear;
wherein the middle gear is movable to drive the driven gear through the driving gear so that the electric window covering is retractable and extendable electrically; the middle gear being movable to make the driving gear not driving the driven gear such that the electric window covering is retractable and extendable manually.

18. The clutch for the electric window covering of claim 17 further having a pusher which has one end pivotally coupled with the middle gear; the pusher being movable towards one end to allow the middle gear to be engaged with the driving gear and the driven gear at the same time; the pusher being movable towards another end to allow the middle gear to be disengaged with the driving gear and the driven gear.

19. The clutch for the electric window covering of claim 18, wherein the electric window covering has a battery box which has a slot to allow another end of the pusher to be extended outside the surface of the battery box.
